(19) United States
(12) Patent Application Publication
(10) Pub. No.: US 2025/0048171 A1
(43) Pub. Date: Feb. 6, 2025

(54) A Method for Reporting PDCP Package Delays in Dual Connectivity Scenarios

(71) Applicant: Telefonaktiebolaget LM Ericsson (publ), Stockholm (SE)

(72) Inventors: Sakib Bin Redhwan, Linköping (SE); Pradeepa Ramachandra, Linköping (SE); Angelo Centonza, Granada (ES); Marco Belleschi, Solna (SE); Panagiotis Saltsidis, Stockholm (SE); Johan Rune, Lidingö (SE)

(21) Appl. No.: 18/716,373

(22) PCT Filed: Dec. 6, 2022
(86) PCT No.: PCT/SE2022/051150

§ 371 Date: Jun. 4, 2024

Related U.S. Application Data
(60) Provisional application No. 63/264,959, filed on Dec. 6, 2021.

(51) Int. Cl. H04W 28/02; H04W 76/15

(52) U.S. Cl. CPC H04W 28/0236; H04W 76/15

(57) ABSTRACT

Embodiments herein relates to a method performed by a network node (12,15,20), for calculating an UL radio access network average delay in a wireless communication network comprising a first radio network node (12) and a second radio network node (13) providing dual connectivity to a UE (10). The network node (12,15,20) applies a weighting to a number of packets respectively sent via the first radio network node (12) and the second radio network node (13) when no packet duplication is applied, wherein the weighting further includes a number of packets sent via the first radio network node (12) and the second radio network node (13) when packet duplication is applied or a time period during which packets were sent via the first radio network node (12) and the second radio network node (13) when packet duplication is applied, and wherein the weighting also includes a respective delay calculation for one or more packets, or periods, with duplication, and one or more packets, or periods, without duplication. The network node (12,15,20) calculates an UL radio access network average delay of a packet transmission taking into account the applied weighting, and further also taking into account an uplink delay component reported by the UE (10), wherein the uplink delay component is not separated into a first radio network node part and a second radio network node part.

### TECHNICAL FIELD

Embodiments herein relate to a network node and a method performed therein regarding wireless communication. Furthermore, a computer program product and a computer-readable storage medium are also provided herein. Especially, embodiments herein relate to handling communication, i.e., calculating uplink (UL) radio access network average delays, in a wireless communication network.

### BACKGROUND

In a typical wireless communication network, user equipments (UE), also known as wireless communication devices, mobile stations, stations (STA) and/or wireless devices, communicate via a Radio access Network (RAN) to one or more core networks (CN). The RAN covers a geographical area which is divided into service areas or cell areas, with each service area or cell area being served by network node such as an access node e.g. a Wi-Fi access point or a radio base station (RBS), which in some radio access technologies (RAT) may also be called, for example, a NodeB, an evolved NodeB (eNodeB) and a gNodeB (gNB). The service area or cell area is a geographical area where radio coverage is provided by the radio network node. The radio network node operates on radio frequencies to communicate over an air interface with the wireless devices within range of the access node. The radio network node communicates over a downlink (DL) to the wireless device and the wireless device communicates over an uplink (UL) to the access node.

A Universal Mobile Telecommunications System (UMTS) is a third generation telecommunication network, which evolved from the second generation (2G) Global System for Mobile Communications (GSM). The UMTS terrestrial radio access network (UTRAN) is essentially a RAN using wideband code division multiple access (WCDMA) and/or High-Speed Packet Access (HSPA) for communication with user equipments. In a forum known as the Third Generation Partnership Project (3GPP), telecommunications suppliers propose and agree upon standards for present and future generation networks and UTRAN specifically, and investigate enhanced data rate and radio capacity. In some RANs, e.g. as in UMTS, several radio network nodes may be connected, e.g., by landlines or microwave, to a controller node, such as a radio network controller (RNC) or a base station controller (BSC), which supervises and coordinates various activities of the plural radio network nodes connected thereto. The RNCs are typically connected to one or more core networks.

Specifications for the Evolved Packet System (EPS) have been completed within the 3^{rd} Generation Partnership Project (3GPP) and this work continues in the coming 3GPP releases (Rel). The EPS comprises the Evolved Universal Terrestrial Radio Access Network (E-UTRAN), also known as the Long-Term Evolution (LTE) radio access network, and the Evolved Packet Core (EPC), also known as System Architecture Evolution (SAE) core network. E-UTRAN/LTE is a 3GPP radio access technology wherein the radio network nodes are directly connected to the EPC core network. As such, the Radio Access Network (RAN) of an EPS has an essentially “flat” architecture comprising radio network nodes connected directly to one or more core networks.

With the emerging 5G technologies also known as new radio NR, the use of very many transmit- and receive-antenna elements is of great interest as it makes it possible to utilize beamforming, such as transmit-side and receive-side beamforming. Transmit-side beamforming means that the transmitter can amplify the transmitted signals in a selected direction or directions, while suppressing the transmitted signals in other directions. Similarly, on the receive-side, a receiver can amplify signals from a selected direction or directions, while suppressing unwanted signals from other directions.

Beamforming allows the signal to be stronger for an individual connection. On the transmit-side this may be achieved by a concentration of the transmitted power in the desired direction(s), and on the receive-side this may be achieved by an increased receiver sensitivity in the desired direction(s). This beamforming enhances throughput and coverage of the connection. It also allows reducing the interference from unwanted signals, thereby enabling several simultaneous transmissions over multiple individual connections using the same resources in the time-frequency grid, so-called multi-user Multiple Input Multiple Output (MIMO).

Carrier Aggregation (CA) is generally used in NR and LTE systems to improve UE transmit receive data rate. With carrier aggregation, the UE typically operates initially on single serving cell called a primary cell (Pcell). The Pcell is operated on a component carrier in a frequency band. The UE is then configured by the network with one or more secondary cell (SCell) or secondary serving cells (Scell(s)). Each Scell can correspond to a component carrier (CC) in the same frequency band (intra-band CA) or different frequency band (inter-band CA) from the frequency band of the CC corresponding to the Pcell. For the UE to transmit/receive data on the Scell(s) (e.g by receiving downlink-shared channel (DL-SCH) information on a physical downlink shared channel (PDSCH) or by transmitting uplink-shared channel (UL-SCH) on a physical uplink shared channel (PUSCH)), the Scell(s) need to be activated by the network. The Scell(s) may also be deactivated and later reactivated as needed via activation/deactivation signalling.

The current 5G RAN (NG-RAN) architecture is depicted and described in TS 38.401 v. 15.4.0 as follows.

FIG. 1 illustrates an overall architecture.

The next generation (NG) architecture can be further described as follows. The NG-RAN consists of a set of gNBs connected to the 5G core (5GC) through the NG. An gNB can support frequency division duplex (FDD) mode, time division duplex (TDD) mode or dual mode operation. gNBs can be interconnected through the Xn interface. A gNB may consist of a gNB-central unit (CU) and gNB-distributed units (DU). A gNB-CU and a gNB-DU are connected via F1 logical interface. One gNB-DU is connected to only one gNB-CU. For resiliency, a gNB-DU may be connected to multiple gNB-CU by appropriate implementation. NG, Xn, and F1 are logical interfaces. The NG-RAN is layered into a Radio Network Layer (RNL) and a Transport Network Layer (TNL). The NG-RAN architecture, i.e., the NG-RAN logical nodes and interfaces between them, is defined as part of the RNL. For each NG-RAN interface (NG, Xn, F1), the related TNL protocol and the functionality are specified. The TNL provides services for user plane transport and signalling transport.

A gNB may also be connected to an LTE eNB via the X2 interface. Another architectural option is that where an LTE eNB connected to the Evolved Packet Core network is connected over the X2 interface with a so called nr-gNB. The latter is a gNB not connected directly to a CN and connected via X2 to an eNB for the sole purpose of performing dual connectivity.

The architecture in FIG. 1 can be expanded by spitting the gNB-CU into two entities, such as one gNB-central unit user plane (CU-UP), which serves the user plane and hosts a packet data convergence protocol (PDCP) protocol, and one gNB-central unit-control plane (CU-CP), which serves the control plane and hosts the PDCP and radio resource control (RRC) protocol. For completeness it should be said that a gNB-DU hosts the radio link control (RLC)/medium access control (MAC)/physical (PHY) protocols.

Immediate minimization drive test (MDT) is standardized so that the management systems can collect the key performance indicators (KPI) associated to a UE in the connected mode. The following excerpts from TS 37.320 v 16.1.0 provide some configuration and reporting of measurements in immediate MDT.

Below are the following Immediate MDT procedures described.

### Measurement Configuration.

For Immediate MDT, RAN measurements and UE measurements can be configured. The configuration for UE measurements is based on the existing RRC measurement procedures for configuration and reporting with some extensions for location information.

NOTE: No extensions related to a time stamp are expected for Immediate MDT, i.e., time stamp is expected to be provided by eNB/RNC/gNB.

If area scope is included in the MDT configuration provided to the RAN, the UE is configured with respective measurement when the UE is connected to a cell that is part of the configured area scope.

### Measurement Reporting.

For Immediate MDT, the UE provides detailed location information, e.g., Global Navigation Satellite Systems (GNSS) location information, if available. The UE also provides available neighbour cell measurement information that may be used to determine the UE location, a so called radio frequency (RF) fingerprint. E-UTRAN Cell Global Identifier (ECGI), Cell-Id, or Cell Identity of the serving cell when the measurement was taken is always assumed known in E-UTRAN, UTRAN, or NR respectively.

The location information which comes with UE radio measurements for MDT can be correlated with other MDT measurements, e.g., RAN measurements. For MDT measurements where UE location information is provided separately, it is assumed that the correlation of location information and MDT measurements should be done in a Trace Collection Entity (TCE) based on time stamps.

### Measurements and Reporting Triggers for Immediate MDT.

Measurements to be performed for Immediate MDT purposes involve reporting triggers and criteria utilized for radio resource management (RRM). An MDT specific UE-based measurement for UL PDCP delay is applied for quality of service (QoS) verification purpose. In addition, there are measurements performed in gNB.

In particular, the following measurements are relevant herein, a detailed list can be found in TS 37.320, Universal Terrestrial Radio Access (UTRA) and Evolved Universal Terrestrial Radio Access (E-UTRA); Radio measurement collection for Minimization of Drive Tests (MDT); Overall description; Stage 2, V 16.6.0.
M6: Packet Delay measurement separately for DL and UL, per data radio bearer (DRB) per UE, TS 28.552 [Management and orchestration; 5G performance measurements, V 17.4.0, and TS 38.314, NR; Layer2 measurements, version 16.4.0, 3GPP.

### Measurement Collection Triggers:

For M6:
End of measurement collection period.

### Immediate MDT for Multi RAT (MR)—Dual Connectivity (DC).

In signalling based immediate MDT, access and mobility management function (AMF) provides MDT configuration for both master node (MN) and secondary node (SN) towards MN including multi RAT SN configuration, specifically E-UTRA and NR MDT configuration. MN then forwards the NR MDT configuration towards SN, EN-DC scenario, SN is always NR.

In management-based immediate MDT, operations, administrations, maintenance (OAM) provides the MDT configuration to both MN and SN independently. For both MN and SN, management based MDT should not overwrite signalling based MDT.

For immediate MDT configuration, MN and SN can independently configure and receive measurement from the UE.

### Ran Delay.

The RAN internal delay can be split into multiple components and they are captured in TS 38.314, NR; Layer 2 measurements, version 16.4.0, 3GPPspecification. The following excerpts from TS 38.314 provides some details of these components that make up RAN delay.

The DL packet delay measurements, i.e., D1 (the DL delay in over-the-air interface), D2 (the DL delay in gNB-DU), D3 (the DL delay on F1-U) and D4 (the DL delay in CU-UP), should be measured per DRB per UE.

The RAN part, including UE, of UL packet delay measurement comprises:
D1 (UL PDCP packet average delay, as defined in clause 4.3.1.1).
D2.1 (average over-the-air interface packet delay, as defined in 4.2.1.2.2).
D2.2 (average RLC packet delay, as defined in 4.2.1.2.3).
D2.3 (average delay UL on F1-U, it is measured using the same metric as the average delay DL on F1-U defined in TS 28.552; Management and orchestration; 5G performance measurements, V 17.4.0 clause 5.1.3.3.2).
D2.4 (average PDCP re-ordering delay, as defined in 4.2.1.2.4).

The UL packet delay measurements, i.e., D1 (UL PDCP packet average delay), D2.1 (average over-the-air interface packet delay), D2.2 (average RLC packet delay), D2.3 (average delay UL on F1-U) and D2.4 (average PDCP re-ordering delay), should be measured per DRB per UE. The unit of D1, D2.1, D2.2, D2.3 and D2.4 is 0.1 ms.

For non CU-DU split case, RAN part of packet delay excludes the delay at FI-U interface, i.e. D2.3 and D3.

For the QoS monitoring in TS 23.501 V 16.0.0, RAN informs the RAN part of UL packet delay measurement, or the RAN part of DL packet delay measurement, or both to the CN.

Further formulae for calculating D1 (UL PDCP packet average delay) can be found in 38.314, NR; Layer 2 measurements, version 16.4.0, 3GPP.

### Split Bearer Configuration.

In MR-DC, from a UE perspective, three bearer types exist master cell group (MCG) bearer, secondary cell group (SCG) bearer and split bearer. These three bearer types are depicted in FIG. 2 for MR-DC with EPC (EN-DC) and in FIG. 3 for MR-DC with 5GC (NGEN-DC, NE-DC and NR-DC).

In E-UTRA connected to EPC, if the UE supports EN-DC, regardless whether EN-DC is configured or not, the network can configure either E-UTRA PDCP or NR PDCP for MN terminated MCG bearers while NR PDCP is always used for all other bearers. Change from E-UTRA to NR PDCP or vice-versa can be performed via a reconfiguration procedure, with or without handover, either using release and add of the DRBs or using the full configuration option.

In MR-DC with 5GC, NR PDCP is always used for all bearer types. In NGEN-DC, E-UTRA RLC/MAC is used in the MN while NR RLC/MAC is used in the SN. In NE-DC, NR RLC/MAC is used in the MN while E-UTRA RLC/MAC is used in the SN. In NR-DC, NR RLC/MAC is used in both MN and SN.

FIG. 2 shows a Radio Protocol Architecture for MCG, SCG and split bearers from a UE perspective in MR-DC with EPC (EN-DC).

FIG. 3 shows a Radio Protocol Architecture for MCG, SCG and split bearers from a UE perspective in MR-DC with 5GC (NGEN-DC, NE-DC and NR-DC).

From a network perspective, each bearer, such as MCG, SCG and split bearer, can be terminated either in MN or in SN. Network side protocol termination options are shown in FIG. 4 for MR-DC with EPC (EN-DC) and in FIG. 5 for MR-DC with 5GC (NGEN-DC, NE-DC and NR-DC).

NOTE 1: Even if only SCG bearers are configured for a UE, for signalling radio bearer one (SRB1) and signalling radio bearer two (SRB2) the logical channels are always configured at least in the MCG, i.e., this is still an MR-DC configuration and a PCell always exists.

NOTE 2: If only MCG bearers are configured for a UE, i.e., there is no SCG, this is still considered an MR-DC configuration, as long as at least one of the bearers is terminated in the SN.

FIG. 4 shows network side protocol termination options for MCG, SCG and split bearers in MR-DC with EPC (EN-DC).

FIG. 5 shows network side protocol termination options for MCG, SCG and split bearers in MR-DC with 5GC (NGEN-DC, NE-DC and NR-DC).

### SUMMARY

As part of developing embodiments herein, the following issue or issues were identified.

In 3GPP, measurements of UL PDCP packet average delay in MR-DC scenario have been under discussion and below proposals have been agreed:
1. For QoS monitoring related delay reporting to CN, the minimum value between two legs is defined as the total delay measurement M6 over MCG/SCG for split bearers WITH PDCP duplication.
2. For QoS monitoring related delay reporting to CN, Weighted average, consider the number of packets, over MN and SN′ is used to calculate the total delay measurement M6 over MCG/SCG for split bearers WITHOUT PDCP duplication.
3. For non-duplication and duplication case, a single D1 is calculated.
4. The following method is used for configuring D1 in case of split bearer: only one node can configures D1 to UE, and UE reports D1 to corresponding node where configuration is received.

An assumption regarding delay components is that they can be separated into MN and SN delay, respectively. However, with the recent agreements in 3GPP, a single value for Uplink PDCP average queueing delay, such as a D1, is calculated and reported by the UE towards network. Hence, this part is not separable into MN and SN components. An object of embodiments herein is to provide a mechanism that improves communication with a more reliable delay computation in the wireless communication network.

According to an aspect, the object is achieved by providing a method performed by a network node for calculating an UL radio access network average delay in a wireless communication network comprising a first and a second radio network node providing dual connectivity to a UE. The network node applies a weighting to a number of packets respectively sent via the first radio network node and the second radio network node when no packet duplication is applied or to a time period during which packets were sent via the first radio network node or the second radio network node when no packet duplication is applied, wherein the weighting further includes a number of packets sent via the first radio network node and the second radio network node when packet duplication is applied or a time period during which packets were sent via the first radio network node and the second radio network node when packet duplication is applied, and wherein the weighting also includes a respective delay calculation for one or more packets, or periods, with duplication, and one or more packets, or periods, without duplication. The network node further calculates an UL radio access network average delay of a packet transmission taking into account the applied weighting, and further also taking into account an uplink delay component reported by the UE, wherein the uplink delay component is not separated into a first radio network node part and a second radio network node part.

According to still another aspect, the object is achieved by providing a network node configured to perform the method herein.

Thus, it is herein provided a network node for calculating an UL radio access network average delay in a wireless communication network comprising a first radio network node and a second radio network node providing dual connectivity to a UE. The network node is configured to apply a weighting to a number of packets respectively sent via the first radio network node and the second radio network node when no packet duplication is applied or to a time period during which packets were sent via the first radio network node or the second radio network node when no packet duplication is applied, wherein the weighting further includes a number of packets sent via the first radio network node and the second radio network node when packet duplication is applied or a time period during which packets were sent via the first radio network node and the second radio network node when packet duplication is applied, and wherein the weighting also includes a respective delay calculation for one or more packets, or periods, with duplication, and one or more packets, or periods, without duplication. The network node is configured to calculate an UL radio access network average delay of a packet transmission taking into account the applied weighting, and further also taking into account an uplink delay component reported by the UE, wherein the uplink delay component is not separated into a first radio network node part and a second radio network node part.

It is furthermore provided herein a computer program product comprising instructions, which, when executed on at least one processor, cause the at least one processor to carry out any of the methods herein, as performed by the network node. It is additionally provided herein a computer-readable storage medium, having stored thereon a computer program product comprising instructions which, when executed on at least one processor, cause the at least one processor to carry out any of the methods herein, as performed by the network node.

It is herein disclosed a weighted averaging-based method to compute the total UL RAN average delay for a given bearer in the split bearer scenario. The weighting is applied to the number of packets or time periods when packet duplication and no packet duplication are applied. Furthermore, to handle scenarios where the configuration changes between packet duplication and no packet duplication during the measurement period is applied, weighting is also applied for the respective delay calculation measurements/methods for the periods and/or packets with duplication and the periods and/or packets without duplication.

The network node calculates the UL RAN average delay by further taking into account that at least one delay component that is not separable into MN and SN delays.

It is herein proposed a formulae to calculate UL RAN average delay in a split-bearer scenario. The solution takes account of the constraint that in uplink, at least one part of the delay component is not separated into MN and SN delay components.

Embodiments herein provide a more accurate reflection of the UL RAN average delay experienced by the packets in the split bearer deployments for the entirety of the averaging duration. Thus, it is herein disclosed a solution that allows an accurate calculation of the UL RAN average delay, resulting in an improved performance of the wireless communication network.

### BRIEF DESCRIPTION OF THE DRAWINGS

Embodiments will now be described in more detail in relation to the enclosed drawings, in which:

FIG. 1 illustrates Scell activation/deactivation related procedures specified for Rel15 NR;

FIG. 2 shows a Radio Protocol Architecture for MCG, SCG and split bearers from a UE perspective in MR-DC with EPC (EN-DC);

FIG. 3 shows a Radio Protocol Architecture for MCG, SCG and split bearers from a UE perspective in MR-DC with 5GC (NGEN-DC, NE-DC and NR-DC);

FIG. 4 shows network side protocol termination options for MCG, SCG and split bearers in MR-DC with EPC (EN-DC);

FIG. 5 shows network side protocol termination options for MCG, SCG and split bearers in MR-DC with 5GC (NGEN-DC, NE-DC and NR-DC);

FIG. 6 is a schematic overview depicting a wireless communication network according to embodiments herein;

FIGS. 7A, 7B, 7C are flowcharts depicting methods performed by network nodes according to embodiments herein;

FIGS. 8A, 8B are block diagrams depicting network nodes according to embodiments herein;

FIGS. 9A, 9B are block diagrams depicting radio network nodes according to embodiments herein;

FIG. 10 schematically illustrates a telecommunication network connected via an intermediate network to a host computer;

FIG. 11 is a generalized block diagram of a host computer communicating via a base station with a user equipment over a partially wireless connection; and

FIGS. 12, 13, 14, and 15 are flowcharts illustrating methods implemented in a communication system including a host computer, a base station and a user equipment.

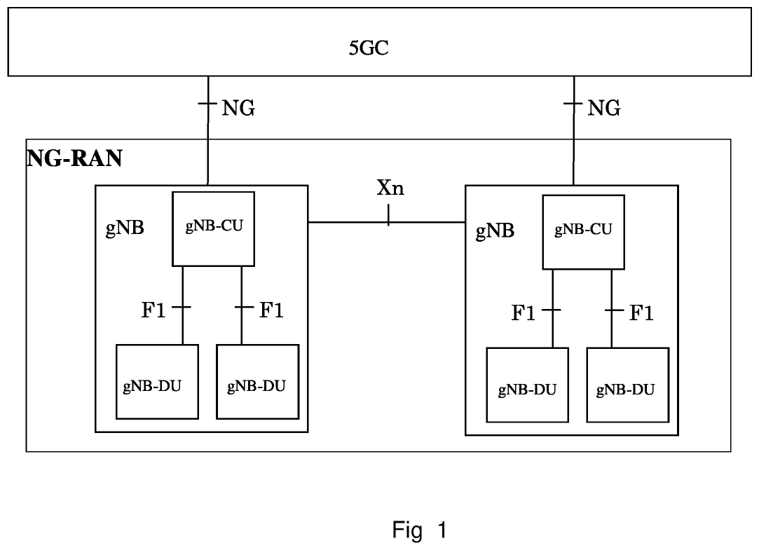

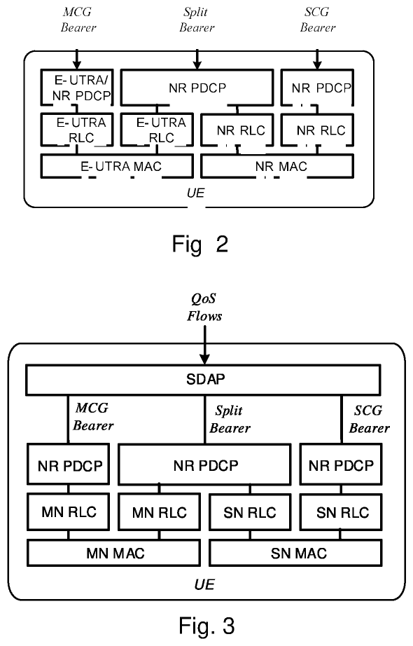

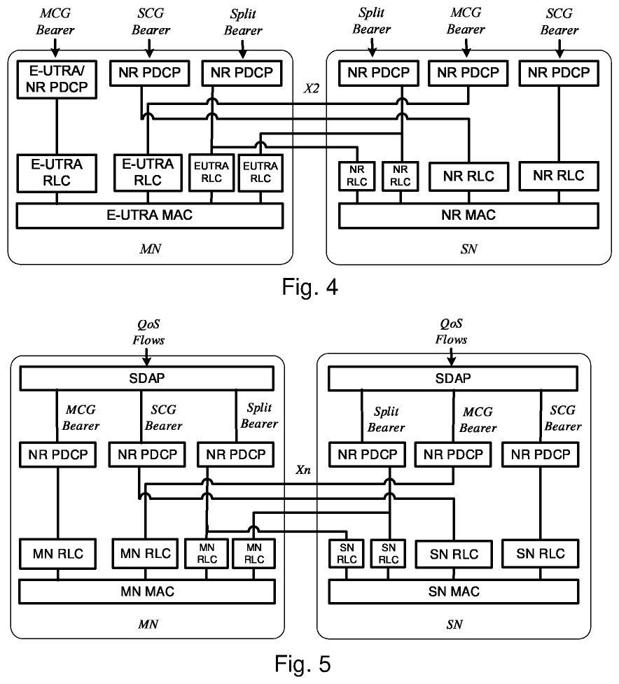

### DETAILED DESCRIPTION

Embodiments herein are described within the context of 3GPP NR radio technology, 3GPP TS 38.300 V15.2.0 (2018-06). It is understood that the problems and solutions described herein are equally applicable to wireless access networks and user-equipments (UEs) implementing other access technologies and standards. NR is used as an example technology where embodiments are suitable, and using NR in the description therefore is particularly useful for understanding the problem and solutions solving the problem. In particular, embodiments are applicable also to 3GPP LTE, or 3GPP LTE and NR integration, also denoted as non-standalone NR.

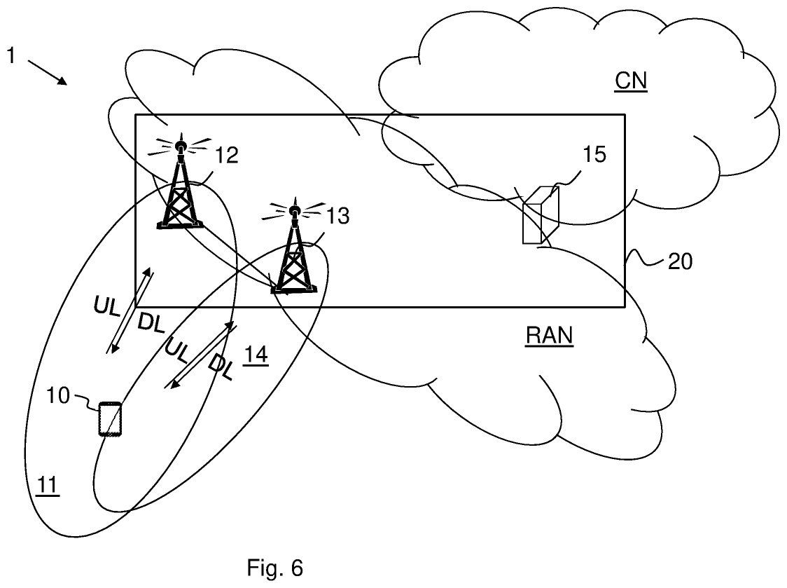

Embodiments herein relate to wireless communication networks in general. FIG. 6 is a schematic overview depicting a wireless communication network 1. The wireless communication network 1 comprises one or more RANs and one or more CNs. The wireless communication network 1 may use one or a number of different technologies, such as Wi-Fi, Long Term Evolution (LTE), LTE-Advanced, Fifth Generation (5G), Wdeband Code Division Multiple Access (WCDMA), Global System for Mobile communications/enhanced Data rate for GSM Evolution (GSM/EDGE), Worldwide Interoperability for Microwave Access (WiMax), or Ultra Mobile Broadband (UMB), just to mention a few possible implementations. Embodiments herein relate to recent technology trends that are of particular interest in a 5G context, however, embodiments are also applicable in further development of the existing wireless communication systems such as e.g. WCDMA and LTE.

In the wireless communication network 1, wireless devices, e.g., a UE 10 such as a mobile station, a non-access point (non-AP) STA, a STA, a user equipment and/or a wireless terminal, communicate via one or more Access Networks (AN), e.g. RAN, to one or more core networks (CN). It should be understood by the skilled in the art that “UE” is a non-limiting term which means any terminal, wireless communication terminal, user equipment, Machine Type Communication (MTC) device, Device to Device (D2D) terminal, or node e.g. smart phone, laptop, mobile phone, sensor, relay, mobile tablets or even a small base station capable of communicating using radio communication with a network node within an area served by the network node.

The wireless communication network 1 comprises a first radio network node 12 providing radio coverage over a geographical area, a first service area 11, i.e., a first cell, of a radio access technology (RAT), such as NR, LTE, Wi-Fi, WIMAX or similar. The first radio network node 12 may be a transmission and reception point e.g. a radio network node such as a Wireless Local Area Network (WLAN) access point or an Access Point Station (AP STA), an access node, an access controller, a base station, e.g. a radio base station such as a NodeB, an evolved Node B (eNB, eNode B), a gNodeB (gNB), a base transceiver station, a radio remote unit, an Access Point Base Station, a base station router, a transmission arrangement of a radio base station, a stand-alone access point or any other network unit or node capable of communicating with a UE within the area served by the first network node 12 depending e.g. on the radio access technology and terminology used. The first radio network node 12 may alternatively or additionally be a controller node or a packet processing node such as a radio controller node or similar. The first radio network node 12 may be referred to as the radio network node, the master node or as a serving network node wherein the first cell may be referred to as a serving cell or primary cell, and the serving network node communicates with the UE 10 in form of DL transmissions to the UE 10 and UL transmissions from the UE 10.

The wireless communication network 1 comprises a second radio network node 13 providing radio coverage over a geographical area, a second service area 14, i.e., a second cell, of a radio access technology (RAT), such as NR, LTE, Wi-Fi, WiMAX or similar. The second radio network node 13 may be a transmission and reception point e.g. a radio network node such as a Wireless Local Area Network (WLAN) access point or an Access Point Station (AP STA), an access node, an access controller, a base station, e.g. a radio base station such as a NodeB, an evolved Node B (eNB, eNode B), a gNodeB (gNB), a base transceiver station, a radio remote unit, an Access Point Base Station, a base station router, a transmission arrangement of a radio base station, a stand-alone access point or any other network unit or node capable of communicating with a UE within the area served by the second radio network node 13 depending e.g. on the radio access technology and terminology used. The second radio network node 13 may alternatively or additionally be a controller node or a packet processing node such as a radio controller node or similar. The second radio network node 13 may be referred to as a secondary serving network node, or a secondary node, wherein the second service area may be referred to as a secondary serving cell or secondary cell, and the serving network node communicates with the UE 10 in form of DL transmissions to the UE 10 and UL transmissions from the UE 10.

The wireless communication network 1 comprises an OAM node 15 managing operation and maintenance in the wireless communication network.

Embodiments herein concern measurement and calculation of delays in the RAN, for the purpose of reporting the obtained delay measure to the CN or to an operation and maintenance (O&M) system, and/or for processing in the RAN, e.g., for self organizing network (SON) purposes, where the obtained measurement results, e.g., may be used to tune or optimize configuration parameters. A weighted averaging method for the computation of the uplink RAN internal delay by the network node hosting a PDCP entity, e.g., CU-UP.

According to embodiments herein a network node 20, which network node may be any node such as a gNB-CU, any radio network node, or the OAM node 15, monitors communication in the wireless communication network. The first radio network node 12 and the second radio network node 13 provide dual connectivity to the UE 10. The network node calculates an UL RAN average delay of packet transmission wherein weighting is applied to the number of packets respectively sent via the first radio network node and the second radio network node when no packet duplication is applied or to a time period during which packets were sent via the first radio network node or the second radio network node when no packet duplication is applied, and wherein the weighting further includes a number of packets sent via the first radio network node 12 and the second radio network node 13 when packet duplication is applied or a time period during which packets were sent via the first radio network node 12 and the second radio network node 13 when packet duplication is applied. Furthermore, weighting is also applied for the respective delay calculation for the one or more periods and/or packets with duplication, and the periods and/or packets without duplication. The network node 20 computing the total uplink RAN average delay measurement may thus know when duplication was enabled and when it was disabled. The calculation is taking into account an uplink delay component reported by the UE 10, wherein the uplink delay component is not separated into a first radio network node part and a second radio network node part. I.e., the uplink delay component may comprise a single value for Uplink PDCP average queueing delay or indicate an UL PDCP packet average delay over a (split) bearer between the UE and the first and second radio network node.

Thus, the network node calculates an average delay of packet transmission, wherein weighting is applied to the number of packets respectively sent via the first radio network node and the second radio network node when no packet duplication is applied. Furthermore, weighting is also applied for the respective delay calculation for the one or more periods or packets with duplication, and the periods or packets without duplication. The calculation is taking into account an uplink delay component reported by the UE, wherein the uplink delay component is not separated into a first radio network node part and a second radio network node part. I.e., the uplink delay component may comprise a single value for Uplink PDCP average queueing delay or indicate an UL PDCP packet average delay over a (split) bearer between the UE and the first and/or the second radio network node.

Note that, in a general scenario, the term “radio network node” can be substituted with “transmission point”. Distinction between the transmission points (TPs) may typically be based on reference signals or different synchronization signals transmitted. Several TPs may be logically connected to the same radio network node but if they are geographically separated, or are pointing in different propagation directions, the TPs may be subject to the same mobility issues as different radio network nodes. In subsequent sections, the terms “radio network node” and “TP” can be thought of as interchangeable.

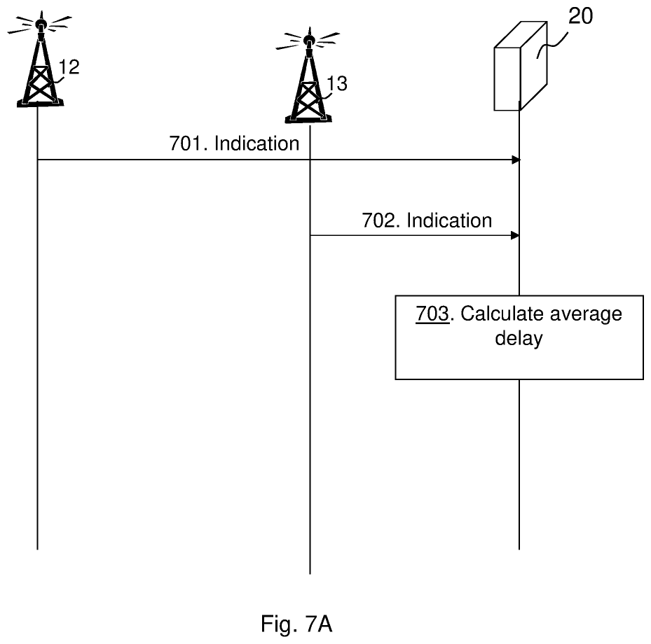

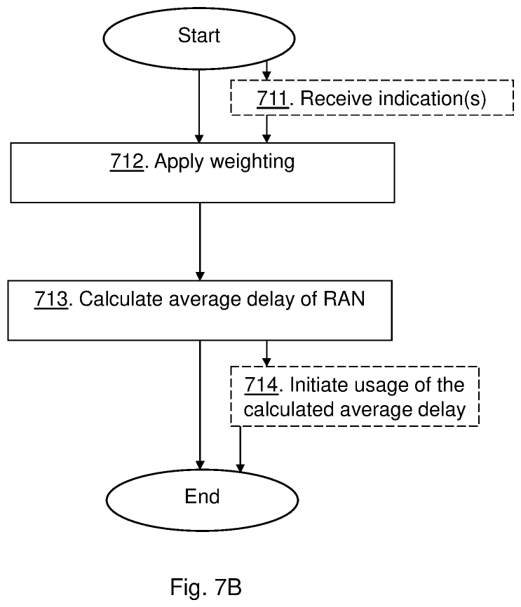

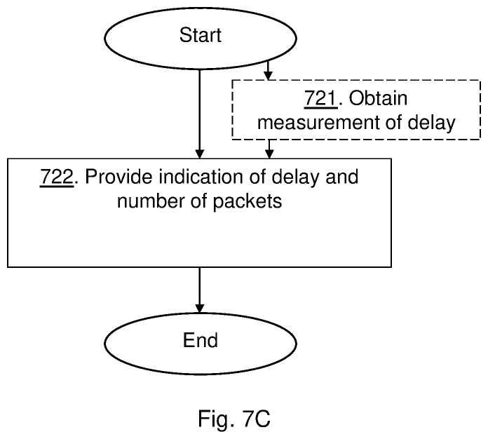

FIG. 7A is a combined flowchart and signalling scheme according to embodiments herein. The actions may be performed in any suitable order.

Action 701. The first radio network node 12 may transmit an indication of a first calculated delay of communicated packets and/or a first number of packets sent via the first radio network node 12 when no packet duplication is applied, and another first calculated delay and/or a second number of packets sent via the first radio network node 12 when packet duplication is applied.

Action 702. The second radio network node 13 may transmit an indication of a second calculated delay of communicated packets and/or a third number of packets sent via the second radio network node when no packet duplication is applied, and another second calculated delay and/or a fourth number of packets sent via the second radio network node 13 when packet duplication is applied.

Action 703. The network node 20, such as the OAM node 15 or a radio network node, calculates an UL radio access network average delay of packet transmission, wherein a weighting is applied to the number of packets respectively sent via the first radio network node 12 and the second radio network node 13 when no packet duplication is applied or to a time period during which packets were sent via the first radio network node or the second radio network node when no packet duplication is applied. The weighting further includes a number of packets sent via the first radio network node 12 and the second radio network node 13 when packet duplication is applied or a time period during which packets were sent via the first radio network node 12 and the second radio network node 13 when packet duplication is applied. Furthermore, the weighting is also applied for the respective delay calculation for the one or more periods or packets with duplication, and the periods or packets without duplication. The calculation is further taking into account the uplink delay component reported by the UE 10, wherein the uplink delay component is not separated into a first radio network node part and a second radio network node part. I.e., the uplink delay component may comprise a single value for Uplink PDCP average queueing delay or indicate an UL PDCP packet average delay over a (split) bearer between the UE and the first and second radio network node.

Embodiments concern the introduction of a weighted averaging method for the computation of the UL RAN average delay by the network node hosting the PDCP, e.g., CU-user plane (UP).

Embodiments propose a weighted averaging-based method to compute the total UL RAN average delay for a given bearer in the split bearer scenario. The weighting is applied to the number of packets respectively sent via the first radio network node 12 and the second radio network node and when configuration changes between packet duplication and no packet duplication during the measurement period, weighting is also applied for the respective delay calculation measurements/methods for the periods and/or packets with duplication and the periods and/or packets without duplication. The network node computing the total delay measurement, that is, the network node 20, may be informed when duplication was enabled and when it was disabled. The network node 20 further calculates the UL RAN average delay taking also the uplink delay component reported by the UE 10, wherein the uplink delay component is not separated into a first radio network node part and a second radio network node part. I.e., the uplink delay component may comprise the single value for Uplink PDCP average queueing delay or indicate the UL PDCP packet average delay over the (split) bearer between the UE and the first and second radio network node. This may be reported from the first or the second radio network node.

The method actions performed by the network node 20, such as a central unit, an OAM node, or a radio network node, for handling communication in the wireless communication network comprising the first radio network node 12 and the second radio network node 13 providing dual connectivity to the UE 10 according to embodiments herein, will now be described with reference to a flowchart depicted in FIG. 7B. The actions do not have to be taken in the order stated below, but may be taken in any suitable order. Actions performed in some embodiments are marked with dashed boxes.

Action 711. The network node 20 may obtain an indication of the respective delay calculation and number of packets transmitted with duplication over a first period, and/or another indication indicating a delay of respective radio network node and number of packets sent via the radio network node with non-duplication over a second period. Thus, the network node 20 may obtain indications of delay of the respective radio network node and number of packets transmitted with duplication and/or non-duplication over a respective period. This may be obtained from within, from UEs, radio network nodes, or from another network node.

Action 712. The network node 20 applies a weighting to a number of packets respectively sent via the first radio network node 12 and the second radio network node 13 when no packet duplication is applied or to the time period during which packets were sent via the first radio network node or the second radio network node when no packet duplication is applied, wherein the weighting further includes a number of packets sent via the first radio network node 12 and the second radio network node 13 when packet duplication is applied or a time period during which packets were sent via the first radio network node 12 and the second radio network node 13 when packet duplication is applied, and wherein the weighting also includes a respective delay calculation for one or more packets, or periods, with duplication, and one or more packets, or periods, without duplication

Action 713. The network node 20 calculates the UL radio access network average delay of packet transmission of a packet transmission taking into account the applied weighting, and further also taking into account an uplink delay component reported by the UE 10, wherein the uplink delay component is not separated into a first radio network node part and a second radio network node part. The uplink delay component is exemplified below as D_{UE}.

The network node 20 may thus calculate the UL radio access network average delay of packet transmission, wherein weighting is applied to the number of packets respectively sent via the first radio network node 12 and the second radio network node 13 when no packet duplication is applied. Furthermore, the weighting is also applied for the respective delay calculation for the one or more packets, or periods, with duplication, and the packets, or periods, without duplication. The network node 20 may perform weighting by deriving a first weight for a first delay calculated at the first radio network node 12 and a second weight for a second delay calculated at the second radio network node 13, on the basis of at least one of the following:
a first number of packets for a given bearer sent via the first radio network node 12 and a second number of packets sent via the second radio network node when the duplication was not enabled and the first and second delays experienced by packets of the first radio network node and the second radio network node; and
a third number of packets for the given bearer sent via both the first radio network node 12 and the second radio network node 13 when the duplication was enabled and the first and second delays experienced by packets of the first radio network node 12 and the second radio network node 13.

The weighting may comprise

$$\frac{{N}_{Dup} * {D}_{Best} + {N}_{NonDupMN} * {D}_{MN} + {N}_{NonDupSN} * {D}_{SN}}{{N}_{Dup} + {N}_{NonDupMN} + {N}_{NonDupSN}}$$

$$or$$

$$\frac{{T}_{Dup} * {D}_{Best} + {T}_{NonDup} * {D}_{Avg}}{{T}_{Dup} + {T}_{NonDup}} ,$$

see below.

The network node 20 calculates the UL radio access network average delay by furthertaking into account, or considering, the uplink delay component reported by the UE 10, wherein the uplink delay component is not separated into a first radio network node part and a second radio network node part. I.e., the uplink delay component may comprise a single value for Uplink PDCP average queueing delay or indicate an UL PDCP packet average delay over a (split) bearer between the UE and the first and second radio network node.

The calculation may further take into account that a bearer switches between being a split bearer in a dual connectivity scenario and being a “regular” bearer in a single connectivity scenario.

Different SNs or SCG cells may be accounted separately in the weighted average calculation.

The calculation may take into account sub-periods or packets sent in conjunction with different bearer properties.

The calculated UL radio access network average delay may further take into account an average delay in a CU-UP during a measurement period. The average delay in the CU-UP is exemplified below as D_{PDCP}.

Thus, it is herein disclosed calculation of a total UL radio access network average delay denoted below as UL RAN delay.

For example:

### Method 1:

The weighted averaging for the UL RAN delay may be computed based on number of sent packets with the respective bearer properties, i.e., duplicated packets, non-duplicated packets sent towards the MN and non-duplicated packets sent towards the SN, as follows.

$Total UL RAN delay = {D}_{PDCP} + \frac{\begin{matrix}{N}_{Dup} * {D}_{Best} + {N}_{NonDupMN} * \\ {D}_{MN} + {N}_{NonDupSN} * {D}_{SN}\end{matrix}}{{N}_{Dup} + {N}_{NonDupMN} + {N}_{NonDupSN}} + {D}_{UE}$
where,

| D_{PDCP} | The average delay in the CU-UP during the measurement | |
|---|---|---|
| | period. | |
| N_{Dup} | The number of packets duplicated via both MN and SN | |
| | during the measurement period. | |
| D_{Best} | The minimum of the average delay experienced on the | |
| | MN and the average delay experienced on the SN i.e., | |
| | D_{Best} = Min (D_{MN}, D_{SN}) | |
| | An alternative way to calculate D_{Best} is to determine the | |
| | minimum delay for each duplicated packet and then | |
| | compute the average of this. The formula for D_{Best} | |
| | would then be: | |
| | ${D}_{Best} = \frac{{\sum }_{i = 1}^{{N}_{Dup}} min ( {D}_{MN , i} , {D}_{SN , i} )}{{N}_{Dup}}$ | |
| | where “D_{MN, i}” is the delay of packet i on the leg via the | |
| | MN and “D_{SN, i}” is the delay of packet i on the leg via | |
| | the SN. | |
| | Furthermore, | |
| | D_{MN, i} = D_{MN-F1, i} + D_{MN-DU, i} + D_{MN-air, i} | |
| | and | |
| | D_{SN, i} = D_{SN -F1, i} + D_{SN-DU, i} + D_{SN-air, i} | |
| N_{NonDupMN} | The number of packets sent via MN when the PDCP | |
| | duplication is not enabled during the measurement period. | |
| D_{UE} | Average PDCP queueing delay as measured by the UE; | |
| | this is the uplink delay component reported by the UE | |
| D_{MN} | The average delay experienced by the packets sent on the | |
| | MN during the measurement period. This average delay is | |
| | performed as follows. | |
| | D_{MN} = D_{MN-F1} + D_{MN-DU} + D_{MN-air} | |
| | wherein, | |
| | D_{MN-F1} | Average delay over F1-U interface (be- |
| | | tween the CU-UP and the MN gNB-DU) |
| | D_{MN-DU} | Average delay within the MN DU (i.e., the |
| | | processing delay) |
| | D_{MN-air} | Average delay over the air interface be- |
| | | tween the MN gNB-DU and the UE. |
| N_{NonDupSN} | The number of packets sent via SN when the PDCP | |
| | duplication is not enabled during the measurement | |
| | period. | |
| D_{SN} | The average delay experienced by the packets sent on the | |
| | SN during the measurement period. This average delay is | |
| | performed as follows. | |
| | D_{SN} = D_{SN-F1} + D_{SN-DU} + D_{SN-air} | |
| | wherein, | |
| | D_{SN-F1} | Average delay over F1-U interface (be- |
| | | tween the CU-UP and the SN gNB-DU) |
| | D_{SN-DU} | Average delay within the SN DU (i.e., the |
| | | processing delay) |
| | D_{SN-air} | Average delay over the air interface be- |
| | | tween the SN gNB-DU and the UE. |

### Method 2.

In this method, the weighted averaging for the UL RAN delay is computed, based on the relative time periods during which packet duplication or non-duplication is configured, irrespective of the number of packets transmitted during these time periods, as follows:

$Total UL RAN delay = {D}_{PDCP} + \frac{{T}_{Dup} * {D}_{Best} + {T}_{NonDup} * {D}_{Avg}}{{T}_{Dup} + {T}_{NonDup}} + {D}_{UE}$
where,

| D_{PDCP} | The average delay in the CU-UP during the measurement | |
|---|---|---|
| | period. | |
| T_{Dup} | The time duration or period during which the packets were | |
| | duplicated via both MN and SN during the measurement | |
| | period. | |
| D_{Best} | The minimum of the average delay experienced on the MN | |
| | and the average delay experienced on the SN i.e., | |
| | D_{Best} = Min (D_{MN}, D_{SN}) | |
| | An alternative way to calculate D_{Best} is to determine the | |
| | minimum delay for each duplicated packet and then | |
| | compute the average of this. The formula for D_{Best} | |
| | would then be: | |
| | ${D}_{Best} = \frac{{\sum }_{i = 1}^{{N}_{Dup}} min ( {D}_{MN , i} , {D}_{SN , i} )}{{N}_{Dup}}$ | |
| | where “D_{MN, i}” is the delay of packet i on the leg via the | |
| | MN and “D_{SN, i}” is the delay of packet i on the leg via | |
| | the SN. | |
| | Furthermore, | |
| | D_{MN, i} = D_{MN-F1, i} + D_{MN-DU, i} + D_{MN-air, i} | |
| | and | |
| | D_{SN, i} = D_{SN-F1, i} + D_{SN-DU, i} + D_{SN-air, i} | |
| T_{NonDup} | The time duration or period during which the packets were | |
| | sent via MN or via the SN i.e., the PDCP duplication is | |
| | not enabled during the measurement period | |
| D_{UE} | Average PDCP queueing delay as measured by the UE | |
| D_{Avg} | The average delay experienced by the packets sent on the | |
| | MN or SN during the measurement period. This average | |
| | delay is performed as follows. | |
| | ${D}_{Avg} = \frac{{N}_{NonDupMN} * {D}_{MN} + {N}_{NonDupSN} * {D}_{SN}}{{N}_{NonDupMN} + {N}_{NonDupSN}}$ | |
| | wherein, | |
| | D_{MN} | The average delay experienced by the |
| | | packets sent on the MN during the |
| | | measurement period (calculated as in |
| | | method 1). |
| | D_{SN} | The average delay experienced by the |
| | | packets sent on the SN during the |
| | | measurement period (calculated as in |
| | | method 1). |
| | N_{NonDupMN} | The number of packets sent via MN when |
| | | the PDCP duplication is not enabled |
| | | during the measurement period.. |
| | N_{NonDupSN} | The number of packets sent via SN when |
| | | the PDCP duplication is not enabled |
| | | during the measurement period. |

Action 714. The network node 20 may then initiate usage of the calculated UL radio access network average delay. For example, the network node may initiate use the calculated UL radio access network average delay for operation administration and maintenance (OAM) performance observability or for QoS verification of MDT or for QoS monitoring. The network node 20 may report the total UL RAN average delay, as computed above, to an OAM node or other network node.

The method actions performed by the radio network node, such as the first or the second radio network node, for handling communication (of the UE) in the wireless communication network comprising the first and the second radio network node providing dual connectivity to the UE 10 according to embodiments herein will now be described with reference to a flowchart depicted in FIG. 7C. The actions do not have to be taken in the order stated below, but may be taken in any suitable order. Actions performed in some embodiments are marked with dashed boxes.

Action 721. The radio network node may obtain indications, measurements, calculations related to delay of communicated packets.

Action 722. The radio network node provides, to the network node, the indication indicating the delay and the number of packets sent via the radio network node when no packet duplication is applied over a first period, and/or another indication indicating the delay and the number of packets sent via the radio network node when duplication is applied over a second period. For example, the radio network node may transmit to the network node, such as another radio network node or an OAM node e.g. a TCE, one or more indications indicating delay of communicated packets and/or number of packets transmitted with duplication and/or non-duplication over a respective period.

Further embodiments related to UL RAN average delay reporting to the CN or the O&M system (and/or for processing in the RAN).

In some embodiments, the network node 20 comprising a CU-UP reports the total UL RAN average delay as computed by either of the methods listed above to the CN.

Calculating/reporting the minimum, maximum and total UL RAN average delay.

The CU-UP may measure/calculate and/or report the total UL RAN average delay, the minimum and maximum RAN delays, for duplicated packets, to the CN wherein the minimum UL RAN delay is the same as Dess and the maximum UL RAN delay is the Max(D_{MN}, D_{SN}). Similarly, as was described for the D_{BEST} calculation above, an alternative way of calculating the maximum UL RAN delay D_{RAN-Max}, is

$${D}_{Best} = \frac{{\sum }_{i = 1}^{{N}_{Dup}} max ( {D}_{MN , i} , {D}_{SN , i} )}{{N}_{Dup}} + {D}_{UE}$$

$${D}_{MN , i} = {D}_{MN - F 1 , i} + {D}_{MN - DU , i} + {D}_{MN - air , i}$$

$$and$$

$${D}_{SN , i} = {D}_{SN - F 1 , i} + {D}_{SN - DU , i} + {D}_{SN - air , i}$$

Taking switches between split bearer and single connectivity “bearer modes” into account

In some embodiments, the delay measurement takes into account that a bearer may switch between being a split bearer in a dual connectivity scenario and being a “regular” bearer in a single connectivity scenario, e.g., if an secondary cell (SCell) is added or removed. Similarly, even in a persistent dual connectivity scenario, the bearer may switch between being a split bearer, via both the MN and the SN, and being a “regular” bearer, either only in an MCG cell or only in an SCG cell. Weighted averages may be computed for these “bearer modes” separately, similarly as previously described for a bearer switching between packet duplication and no packet duplication.

Extending method 1 above with this aspect gives the following formula for the total RAN delay (which may be denoted as method 1a):

$$\begin{matrix}Total UL RAN delay = {D}_{PDCP} \\ + \frac{\begin{matrix}{N}_{Dup} * {D}_{Best} + {N}_{NonDupMN} * {D}_{MN} + \\ {N}_{NonDupSN} * {D}_{SN} + {N}_{SingCon} * {D}_{SingCon}\end{matrix}}{{N}_{Dup} + {N}_{NonDupMN} + {N}_{NonDupSN} + {N}_{SingCon}} \\ + {D}_{UE}\end{matrix}$$

where N_{SingCon} is the number of packets sent in single connectivity, or “regular” bearer mode in dual connectivity, and D_{SingCon} is the average delay experienced by the packets sent in this “bearer mode” during the measurement period.

In another example, the single connectivity bearer mode is divided into single connectivity in a single connectivity scenario, i.e., where there is no SN, single connectivity towards the MN in a dual connectivity scenario

$$\begin{matrix}Total UL RAN delay = {D}_{PDCP} \\ + \frac{\begin{matrix}\begin{matrix}{N}_{Dup} * {D}_{Best} + {N}_{NonDupMN} * {D}_{MN} + \\ {N}_{NonDupSN} * {D}_{SN} + {N}_{SingCon} * {D}_{SingCon} +\end{matrix} \\ {N}_{SingConMN} * {D}_{SingConMN} + {N}_{SingConSN} * {D}_{SingConSN}\end{matrix}}{\begin{matrix}{N}_{Dup} + {N}_{NonDupMN} + {N}_{NonDupSN} + {N}_{SingCon} + \\ {N}_{SingConMN} + {N}_{SingConSN}\end{matrix}} \\ + {D}_{UE}\end{matrix}$$

where
   N_{SingCon} is the number of packets sent in single connectivity (i.e. without any SN);
   D_{SingCon} is the average delay experienced by the packets sent in single connectivity (i.e. without any SN);
   N_{SingConMN} is the number of packets sent in non-split bearer mode towards the MN;
   D_{SingConMN} is the average delay experienced by the packets sent in non-split bearer mode towards the MN;
   N_{SingConSN} is the number of packets sent in non-split bearer mode towards the SN;
   D_{SingConSN} is the average delay experienced by the packets sent in non-split bearer mode towards the SN;

Method 2 above may also be extended in similar ways, e.g., replacing N_{SingCon}, N_{SingConMN} and N_{SingConSN} with T_{SingCon}, T_{SingConMN} and T_{SingConSN}, representing the time periods spent in the respective “bearer modes”. The result may be denoted as method 2a.

Various hybrids of the above methods and resulting formulae for the total UL RAN delay can be achieved by combining the above concepts and principles in various ways.

Taking changes of SCG cells and/or MCG cells into account.

In some embodiments, it is taken into account in the RAN delay measurement/calculation that the SN, or the SCG cell, may change during the measurement period. To take this into account, delays experienced during connection to different SNs or SCG cells may be accounted for separately in the weighted average calculation.

As an example, to take this into account, method 1 may be extended to the following formula for the total UL RAN delay (which may be denoted as method 1b):

$$Total UL RAN delay = {D}_{PDCP} + \frac{{\sum }_{i = 1}^{{N}_{SCG}} ( {N}_{PacketSCG , i} * {D}_{CombAvg , i} )}{{\sum }_{i = 1}^{{N}_{SCG}} {N}_{PacketSCG , i}} + {D}_{UE}$$

where
   N_{SCG} is the number of SCG cells used during the measurement period;
   N_{PacketSCG,i} is the number of packets sent in SCG cell i;

$${D}_{CombAvg , i} = \frac{{N}_{Dup} * {D}_{Best} + {N}_{NonDupMN} * {D}_{MN} + {N}_{NonDupSN} * {D}_{SN}}{{N}_{Dup} + {N}_{NonDupMN} + {N}_{NonDupSN}}$$

measured/calculated in SCG cell i.

Method 2 above may also be extended in similar ways, e.g. replacing N_{PacketSCG,i} with T_{SPacketSCG,i}, representing the time period spent in SCG cell i. The result may be denoted as method 2b.

If instead of extending method 1 in this way (to method 1b), method 1 is extended to take into account both that a bearer may switch between single and dual connectivity “modes”, as previously described, and that SCG cells may change during the measurement period, Dcmm_{g}s would instead be:

$${D}_{CombAvg , i} = \frac{{N}_{Dup} * {D}_{Best} + {N}_{NonDupMN} * {D}_{MN} + {N}_{NonDupSN} * {D}_{SN} + {N}_{SingCon} * {D}_{SingCon}}{{N}_{Dup} + {N}_{NonDupMN} + {N}_{NonDupSN} + {N}_{SingCon}}$$

measured/calculated in SCG cell i, or

$${D}_{CombAvg , i} = \frac{\begin{matrix}{N}_{Dup} * {D}_{Best} + {N}_{NonDupMN} * {D}_{MN} + {N}_{NonDupSN} * {D}_{SN} + {N}_{SingCon} * {D}_{SingCon} + \\ {N}_{SingConMN} * {D}_{SingConMN} + {N}_{SingConSN} * {D}_{SingConSN}\end{matrix}}{\begin{matrix}{N}_{Dup} + {N}_{NonDupMN} + {N}_{NonDupSN} + \\ {N}_{SingCon} + {N}_{SingConMN} + {N}_{SingConSN}\end{matrix}}$$

measured in SCG cell i.

With these alternatives, there are three versions of method 1b, which could be denoted as method 1b₁, method 1b₂ and method 1b₃.

Changes in the MCG cells during the measurement period may be accounted for in similar ways.

Generalizing the weighted averaging.

So far, it has been described how various aspects, e.g., bearer properties, may be taken into account separately using weighted averaging. This may be extended by taking any combination of the previously described aspects in weighted average calculations to calculate the total UL RAN delay.

Separate delay measurements/calculations for “sub-periods” with different properties.

As an alternative to calculating a weighted average of delays measured/calculated during different sub-periods or for packets sent in conjunction with different bearer properties, it would be possible to measure/calculate and/or report these delays without using them to calculate a weighted average. Optionally, when reporting these delays, the radio network node may, for each delay, indicate which specific sub-period and/or bearer property it is associated with.

### Configurability.

In the previously described embodiments, there are several aspects that could be made configurable, to allow more precise network control of the UL RAN delay measurement and reporting.

For instance, it may be configurable which method the RAN should use to measure/calculate the total UL RAN delay. This configuration, which, e.g., may come in the form of configuration data from the O&M system or from the CN, or in the form of a request from the CN, to the network node 20, and may for instance indicate:
the method the RAN should use out of method 1 and method 2;
the method the RAN should use out of method 1, method 1a and method 1b;
the method the RAN should use out of method 1, method 1a, method 1b, method 2, method 2a and method 2b;
the method the RAN should use out of method 1, method 1a, method 1b₁, method 1b₂ and method 1b₃;
the method the RAN should use out of method 1, method 1a, method 1b₁, method 1b₂, method 1b₃, method 2, method 2a and method 2b; or
whether the RAN should use a method described in the present disclosure, and optionally which method or method variant that the RAN should use.

If the RAN uses an embodiment described above, i.e., if the RAN measures/calculates and/or reports delays separately for different sub-periods and/or for packets sent in conjunction with different bearer properties, the O&M system or the CN may configure which properties that should cause division into separate measurement/calculation and/or reporting. As a further option, the O&M system or the CN could configure which measurement/calculation method the RAN should use for measurement/calculation of delays associated with different sub-periods and/or different bearer properties.

One or more indications may be sent from the RAN, i.e., the network node 20 being a radio network node, about used options/alternatives.

If the RAN is left with autonomous choices of some aspects, such as which method to use for measurement/calculation of delays, the RAN can indicate the choices it has made in the report. For instance, the RAN may indicate which measurement/calculation method it has used. As another example, if the RAN uses an embodiment described above, i.e., if the RAN measures/calculates and/or reports delays separately for different sub-periods and/or for packets sent in conjunction with different bearer properties, the RAN may, for each reported delay, indicate which specific sub-period and/or bearer property it is associated with. As yet another option associated with the use of an embodiment described above, the RAN may indicate, for each reported delay, which delay measurement/calculation method it has used to measure/calculate the delay.

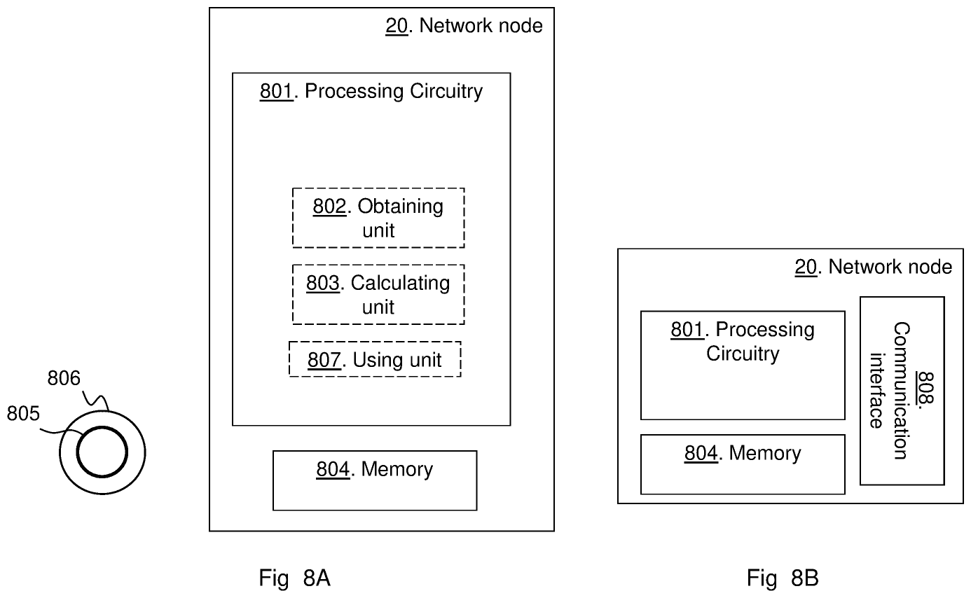

FIGS. 8A and 8B are block diagrams depicting the network node 20, in two embodiments, such as an OAM node e.g. a TCE, or a radio network node, for handling communication in the wireless communication network comprising the first radio network node 12 and the second radio network node 13 providing dual connectivity to the UE 10. Handling herein meaning for example calculating UL RAN average delay in the wireless communication network 1 according to embodiments herein.

The network node 20 may comprise processing circuitry 801, e.g., one or more processors, configured to perform the methods herein.

The network node 20 may comprise an obtaining unit 802, e.g., a receiver or a transceiver. The network node 20, the processing circuitry 801, and/or the obtaining unit 802 may be configured to obtain one or more indications of the respective delay calculation and the number of packets transmitted with duplication over the first period, and/or another indication indicating the delay of respective radio network node and the number of packets sent via the respective radio network node with non-duplication over a second period. Thus, the network node 20, the processing circuitry 801, and/or the obtaining unit 802 may be configured to obtain indications of delay of respective radio network node and/or number of packets transmitted with duplication and/or non-duplication over a respective period. This may be obtained from within or from UEs, radio network nodes, or another network node.

The network node 20 may comprise a calculating unit 803. The network node 20, the processing circuitry 801, and/or the calculating unit 803 is configured to apply the weighting to the number of packets respectively sent via the first radio network node 12 and the second radio network node 13 when no packet duplication is applied or to the time period during which packets were sent via the first radio network node or the second radio network node when no packet duplication is applied, wherein the weighting further includes a number of packets sent via the first radio network node 12 and the second radio network node 13 when packet duplication is applied or a time period during which packets were sent via the first radio network node 12 and the second radio network node 13 when packet duplication is applied, and wherein the weighting also includes the respective delay calculation for one or more packets, or periods, with duplication, and one or more packets, or periods, without duplication.

The network node 20, the processing circuitry 801, and/or the calculating unit 803 is configured to calculate the UL radio access network average delay of the packet transmission taking into account the weighting, and further also taking into account the uplink delay component reported by the UE 10, wherein the uplink delay component is not separated into a first radio network node part and a second radio network node part.

Thus, the network node 20, the processing circuitry 801, and/or the calculating unit 803 is configured to calculate the UL radio access network average delay of packet transmission wherein weighting is applied to the number of packets respectively sent via the first radio network node and the second radio network node when no packet duplication is applied. Furthermore, weighting is also applied for the respective delay calculation for the one or more periods and/or packets with duplication, and the periods and/or packets without duplication. The network node, the processing circuitry 801, and/or the calculating unit 803 may be configured to weight by deriving the first weight for the first delay calculated at the first radio network node and the second weight for a second delay calculated at the second radio network node, on the basis of at least one of the following:
the first number of packets for the given bearer sent via the first radio network node 12 and the second number of packets sent via the second radio network node 13 when the duplication was not enabled, and the first and second delays experienced by the packets of the first radio network node 12 and the second radio network node 13; and the third number of packets for the given bearer sent via both the first radio network node 12 and the second radio network node 13 when the duplication was enabled, and the first and second delays experienced by the packets of the first radio network node 12 and the second radio network node 13.

The calculation of the UL radio access network average delay is taking into account, or considering, the uplink delay component reported by the UE 10, wherein the uplink delay component is not separated into a first radio network node part and a second radio network node part. I.e., the uplink delay component may comprise a single value for Uplink PDCP average queueing delay or indicate an UL PDCP packet average delay over a (split) bearer between the UE and the first and second radio network node.

The calculation of the UL radio access network average delay may further take into account that a bearer switches between being a split bearer in a dual connectivity scenario and being a “regular” bearer in a single connectivity scenario.

Different SNs or SCG cells may be accounted for separately in the weighted average calculation.

The calculation of the UL radio access network average delay may take into account sub-periods or packets sent in conjunction with different bearer properties.

The weighting may comprise

$$\frac{{N}_{Dup} * {D}_{Best} + {N}_{NonDupMN} * {D}_{MN} + {N}_{NonDupSN} * {D}_{SN}}{{N}_{Dup} + {N}_{NonDupMN} + {N}_{NonDupSN}}$$

$$or$$

$$\frac{{T}_{Dup} * {D}_{Best} + {T}_{NonDup} * {D}_{Avg}}{{T}_{Dup} + {T}_{NonDup}} ,$$

see above.

The calculated UL radio access network average delay may further take into account the average delay in a CU-UP during a measurement period.

The network node 20 may comprise a using unit 807. The network node 20, the processing circuitry 801, and/or the using unit 807 may be configured to initiate usage of the calculated UL radio access network average delay. For example, the network node may report the calculated UL radio access network average delay to an OAM node or another network node.

The network node 20 further comprises a memory 804. The memory comprises one or more units to be used to store data on, such as indications, delay components, calculations, UL RAN average delays, number of packets, periods, RSs, strengths or qualities, requests, commands, timers, applications to perform the methods disclosed herein when being executed, and similar.

The network node 20 comprises a communication interface 808 comprising one or more antennas.

The methods according to the embodiments described herein for the network node 20 are respectively implemented by means of, e.g., a computer program product 805 or a computer program, comprising instructions, i.e., software code portions, which, when executed on at least one processor, cause the at least one processor to carry out the actions described herein, as performed by the network node 20. The computer program product 805 may be stored on a computer-readable storage medium 806, e.g., a universal serial bus (USB) stick, a disc or similar. The computer-readable storage medium 806, having stored thereon the computer program product, may comprise the instructions which, when executed on at least one processor, cause the at least one processor to carry out the actions described herein, as performed by the network node 20. In some embodiments, the computer-readable storage medium may be a non-transitory or a transitory computer-readable storage medium.

Thus, the network node is configured to calculate an average delay of a packet transmission, wherein weighting is applied to a number of packets respectively sent via the first radio network node and the second radio network node when no packet duplication is applied, and wherein weighting is further applied for a respective delay calculation for one or more packets and/or periods with duplication, and one or more packets and/or periods without duplication. The calculation is taking into account an uplink delay component reported by the UE, wherein the uplink delay component is not separated into a first radio network node part and a second radio network node part. I.e., the uplink delay component may comprise a single value for Uplink PDCP average queueing delay or indicate an UL PDCP packet average delay over a (split) bearer between the UE and the first and/or the second radio network node.

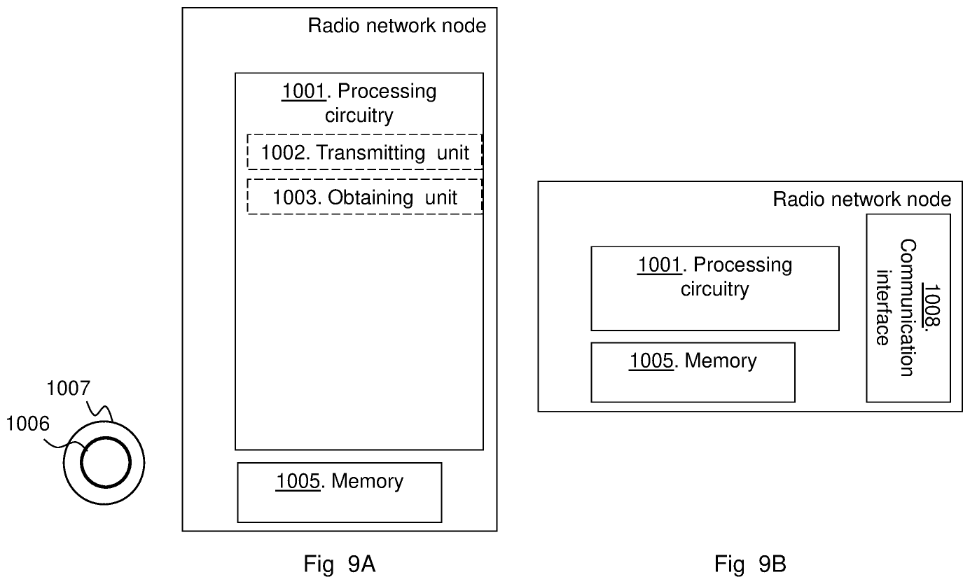

FIGS. 9A and 9B are block diagrams depicting the radio network node, in two embodiments, for handling communication (of the UE) in the wireless communication network 1 comprising the first and the second radio network node providing dual connectivity to the UE such as, e.g., the UE 10, e.g., facilitating the calculation of delay, in the wireless communication network 1 according to embodiments herein.

The radio network node may comprise processing circuitry 1001, e.g. one or more processors, configured to perform the methods herein.

The radio network node may comprise a transmitting unit 1002. The radio network node, the processing circuitry 1001 and/or the transmitting unit 1002 is configured to provide to the network node, the indication indicating the delay and the number of packets sent via the radio network node when no packet duplication is applied over the first period, and/or another indication indicating the delay and the number of packets sent via the radio network node when duplication is applied over the second period. Thus, the radio network node, the processing circuitry 1001 and/or the transmitting unit 1002 may be configured to transmit, to the network node, one or more indications indicating delay of communicated packets and/or number of packets transmitted with duplication and/or non-duplication over a respective period.

The radio network node may comprise an obtaining unit 1003. The radio network node, the processing circuitry 1001 and/or the obtaining unit 1003 may be configured to obtain indications, measurements, calculations related to delay of communicated packets.

The radio network node further comprises a memory 1005. The memory comprises one or more units to be used to store data on, such as WUSs, indications, strengths or qualities, grants, scheduling information, timers, applications to perform the methods disclosed herein when being executed, and similar.

The radio network node comprises a communication interface 1008 comprising transmitter, receiver, transceiver and/or one or more antennas.

The methods according to the embodiments described herein for radio network node are respectively implemented by means of, e.g., a computer program product 1006 or a computer program product, comprising instructions, i.e., software code portions, which, when executed on at least one processor, cause the at least one processor to carry out the actions described herein, as performed by the radio network node. The computer program product 1006 may be stored on a computer-readable storage medium 1007, e.g., a USB stick, a disc or similar. The computer-readable storage medium 1007, having stored thereon the computer program product, may comprise the instructions which, when executed on at least one processor, cause the at least one processor to carry out the actions described herein, as performed by the radio network node. In some embodiments, the computer-readable storage medium may be a non-transitory or transitory computer-readable storage medium.

In some embodiments a more general term “radio network node” is used and it can correspond to any type of radio network node or any network node, which communicates with a wireless device and/or with another network node. Examples of network nodes are NodeB, Master eNB, Secondary eNB, a network node belonging to Master cell group (MCG) or Secondary Cell Group (SCG), base station (BS), multi-standard radio (MSR) radio node such as MSR BS, eNodeB, network controller, radio network controller (RNC), base station controller (BSC), relay, donor node controlling relay, base transceiver station (BTS), access point (AP), transmission points, transmission nodes, Remote Radio Unit (RRU), Remote Radio Head (RRH), nodes in distributed antenna system (DAS), core network node e.g. Mobility Switching Centre (MSC), Mobile Management Entity (MME) etc., Operation and Maintenance (O&M), Operation Support System (OSS), Self-Organizing Network (SON), positioning node e.g. Evolved Serving Mobile Location Centre (E-SMLC), Minimizing Drive Test (MDT) etc.

In some embodiments the non-limiting term wireless device or user equipment (UE) is used and it refers to any type of wireless device communicating with a network node and/or with another UE in a cellular or mobile communication system. Examples of UE are target device, device-to-device (D2D) UE, proximity capable UE (aka ProSe UE), machine type UE or UE capable of machine to machine (M2M) communication, PDA, PAD, Tablet, mobile terminals, smart phone, laptop embedded equipped (LEE), laptop mounted equipment (LME), USB dongles etc.

The embodiments are described for 5G. However the embodiments are applicable to any RAT or multi-RAT systems, where the UE receives and/or transmit signals (e.g. data) e.g. LTE, LTE FDD/TDD, WCDMA/HSPA, GSM/GERAN, Wi Fi, WLAN, CDMA2000 etc.

As will be readily understood by those familiar with communications design, that functions means or modules may be implemented using digital logic and/or one or more microcontrollers, microprocessors, or other digital hardware. In some embodiments, several or all of the various functions may be implemented together, such as in a single application-specific integrated circuit (ASIC), or in two or more separate devices with appropriate hardware and/or software interfaces between them. Several of the functions may be implemented on a processor shared with other functional components of a wireless device or network node, for example.

Alternatively, several of the functional elements of the processing means discussed may be provided through the use of dedicated hardware, while others are provided with hardware for executing software, in association with the appropriate software or firmware. Thus, the term “processor” or “controller” as used herein does not exclusively refer to hardware capable of executing software and may implicitly include, without limitation, digital signal processor (DSP) hardware, read-only memory (ROM) for storing software, random-access memory for storing software and/or program or application data, and non-volatile memory. Other hardware, conventional and/or custom, may also be included. Designers of communications devices will appreciate the cost, performance, and maintenance trade-offs inherent in these design choices.

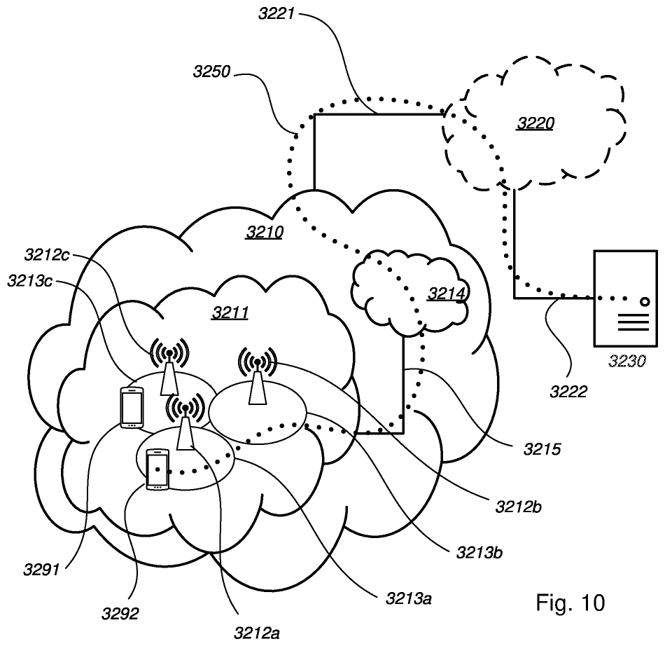

With reference to FIG. 10, in accordance with an embodiment, a communication system includes a telecommunication network 3210, such as a 3GPP-type cellular network, which comprises an access network 3211, such as a radio access network, and a core network 3214. The access network 3211 comprises a plurality of base stations 3212a, 3212b, 3212c, such as NBs, eNBs, gNBs or other types of wireless access points being examples of the radio network node 12 herein, each defining a corresponding coverage area 3213a, 3213b, 3213c. Each base station 3212a, 3212b, 3212c is connectable to the core network 3214 over a wired or wireless connection 3215. A first user equipment (UE) 3291, being an example of the UE 10, located in coverage area 3213c is configured to wirelessly connect to, or be paged by, the corresponding base station 3212c. A second UE 3292 in coverage area 3213a is wirelessly connectable to the corresponding base station 3212a. While a plurality of UEs 3291, 3292 are illustrated in this example, the disclosed embodiments are equally applicable to a situation where a sole UE is in the coverage area or where a sole UE is connecting to the corresponding base station 3212.

The telecommunication network 3210 is itself connected to a host computer 3230, which may be embodied in the hardware and/or software of a standalone server, a cloud-implemented server, a distributed server or as processing resources in a server farm. The host computer 3230 may be under the ownership or control of a service provider, or may be operated by the service provider or on behalf of the service provider. The connections 3221, 3222 between the telecommunication network 3210 and the host computer 3230 may extend directly from the core network 3214 to the host computer 3230 or may go via an optional intermediate network 3220. The intermediate network 3220 may be one of, or a combination of more than one of, a public, private or hosted network; the intermediate network 3220, if any, may be a backbone network or the Internet; in particular, the intermediate network 3220 may comprise two or more sub-networks (not shown).

The communication system of FIG. 10 as a whole enables connectivity between one of the connected UEs 3291, 3292 and the host computer 3230. The connectivity may be described as an over-the-top (OTT) connection 3250. The host computer 3230 and the connected UEs 3291, 3292 are configured to communicate data and/or signaling via the OTT connection 3250, using the access network 3211, the core network 3214, any intermediate network 3220 and possible further infrastructure (not shown) as intermediaries. The OTT connection 3250 may be transparent in the sense that the participating communication devices through which the OTT connection 3250 passes are unaware of routing of uplink and downlink communications. For example, a base station 3212 may not or need not be informed about the past routing of an incoming downlink communication with data originating from a host computer 3230 to be forwarded (e.g., handed over) to a connected UE 3291. Similarly, the base station 3212 need not be aware of the future routing of an outgoing uplink communication originating from the UE 3291 towards the host computer 3230.

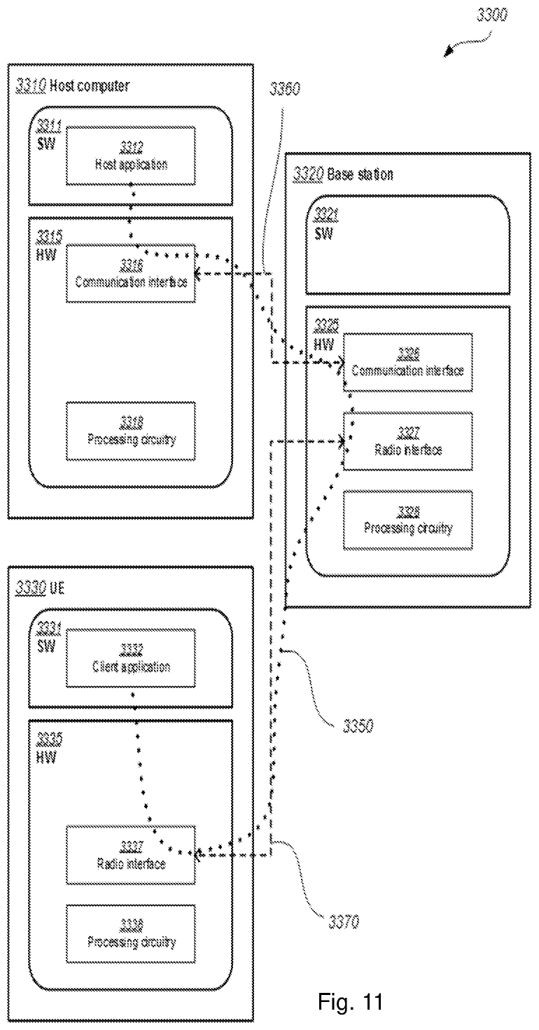

Example implementations, in accordance with an embodiment, of the UE, base station and host computer discussed in the preceding paragraphs will now be described with reference to FIG. 11. In a communication system 3300, a host computer 3310 comprises hardware 3315 including a communication interface 3316 configured to set up and maintain a wired or wireless connection with an interface of a different communication device of the communication system 3300. The host computer 3310 further comprises processing circuitry 3318, which may have storage and/or processing capabilities. In particular, the processing circuitry 3318 may comprise one or more programmable processors, application-specific integrated circuits, field programmable gate arrays or combinations of these (not shown) adapted to execute instructions. The host computer 3310 further comprises software 3311, which is stored in or accessible by the host computer 3310 and executable by the processing circuitry 3318. The software 3311 includes a host application 3312. The host application 3312 may be operable to provide a service to a remote user, such as a UE 3330 connecting via an OTT connection 3350 terminating at the UE 3330 and the host computer 3310. In providing the service to the remote user, the host application 3312 may provide user data which is transmitted using the OTT connection 3350.

The communication system 3300 further includes a base station 3320 provided in a telecommunication system and comprising hardware 3325 enabling it to communicate with the host computer 3310 and with the UE 3330. The hardware 3325 may include a communication interface 3326 for setting up and maintaining a wired or wireless connection with an interface of a different communication device of the communication system 3300, as well as a radio interface 3327 for setting up and maintaining at least a wireless connection 3370 with a UE 3330 located in a coverage area (not shown in FIG. 11) served by the base station 3320. The communication interface 3326 may be configured to facilitate a connection 3360 to the host computer 3310. The connection 3360 may be direct or it may pass through a core network (not shown in FIG. 11) of the telecommunication system and/or through one or more intermediate networks outside the telecommunication system. In the embodiment shown, the hardware 3325 of the base station 3320 further includes processing circuitry 3328, which may comprise one or more programmable processors, application-specific integrated circuits, field programmable gate arrays or combinations of these (not shown) adapted to execute instructions. The base station 3320 further has software 3321 stored internally or accessible via an external connection.

The communication system 3300 further includes the UE 3330 already referred to. Its hardware 3335 may include a radio interface 3337 configured to set up and maintain a wireless connection 3370 with a base station serving a coverage area in which the UE 3330 is currently located. The hardware 3335 of the UE 3330 further includes processing circuitry 3338, which may comprise one or more programmable processors, application-specific integrated circuits, field programmable gate arrays or combinations of these (not shown) adapted to execute instructions. The UE 3330 further comprises software 3331, which is stored in or accessible by the UE 3330 and executable by the processing circuitry 3338. The software 3331 includes a client application 3332. The client application 3332 may be operable to provide a service to a human or non-human user via the UE 3330, with the support of the host computer 3310. In the host computer 3310, an executing host application 3312 may communicate with the executing client application 3332 via the OTT connection 3350 terminating at the UE 3330 and the host computer 3310. In providing the service to the user, the client application 3332 may receive request data from the host application 3312 and provide user data in response to the request data. The OTT connection 3350 may transfer both the request data and the user data. The client application 3332 may interact with the user to generate the user data that it provides.

It is noted that the host computer 3310, base station 3320 and UE 3330 illustrated in FIG. 11 may be identical to the host computer 3230, one of the base stations 3212a, 3212b, 3212c and one of the UEs 3291, 3292 of FIG. 10, respectively. This is to say, the inner workings of these entities may be as shown in FIG. 11 and independently, the surrounding network topology may be that of FIG. 10.

In FIG. 11, the OTT connection 3350 has been drawn abstractly to illustrate the communication between the host computer 3310 and the user equipment 3330 via the base station 3320, without explicit reference to any intermediary devices and the precise routing of messages via these devices. Network infrastructure may determine the routing, which it may be configured to hide from the UE 3330 or from the service provider operating the host computer 3310, or both. While the OTT connection 3350 is active, the network infrastructure may further take decisions by which it dynamically changes the routing (e.g., on the basis of load balancing consideration or reconfiguration of the network).

The wireless connection 3370 between the UE 3330 and the base station 3320 is in accordance with the teachings of the embodiments described throughout this disclosure. One or more of the various embodiments improve the performance of OTT services provided to the UE 3330 using the OTT connection 3350, in which the wireless connection 3370 forms the last segment. More precisely, the teachings of these embodiments may improve the performance since delay is calculated more accurately and thereby provide benefits such as reduced user waiting time, and better responsiveness.

A measurement procedure may be provided for the purpose of monitoring data rate, latency and other factors on which the one or more embodiments improve. There may further be an optional network functionality for reconfiguring the OTT connection 3350 between the host computer 3310 and UE 3330, in response to variations in the measurement results. The measurement procedure and/or the network functionality for reconfiguring the OTT connection 3350 may be implemented in the software 3311 of the host computer 3310 or in the software 3331 of the UE 3330, or both. In embodiments, sensors (not shown) may be deployed in or in association with communication devices through which the OTT connection 3350 passes; the sensors may participate in the measurement procedure by supplying values of the monitored quantities exemplified above, or supplying values of other physical quantities from which software 3311, 3331 may compute or estimate the monitored quantities. The reconfiguring of the OTT connection 3350 may include message format, retransmission settings, preferred routing etc.; the reconfiguring need not affect the base station 3320, and it may be unknown or imperceptible to the base station 3320. Such procedures and functionalities may be known and practiced in the art. In certain embodiments, measurements may involve proprietary UE signaling facilitating the host computer's 3310 measurements of throughput, propagation times, latency and the like. The measurements may be implemented in that the software 3311, 3331 causes messages to be transmitted, in particular empty or ‘dummy’ messages, using the OTT connection 3350 while it monitors propagation times, errors etc.

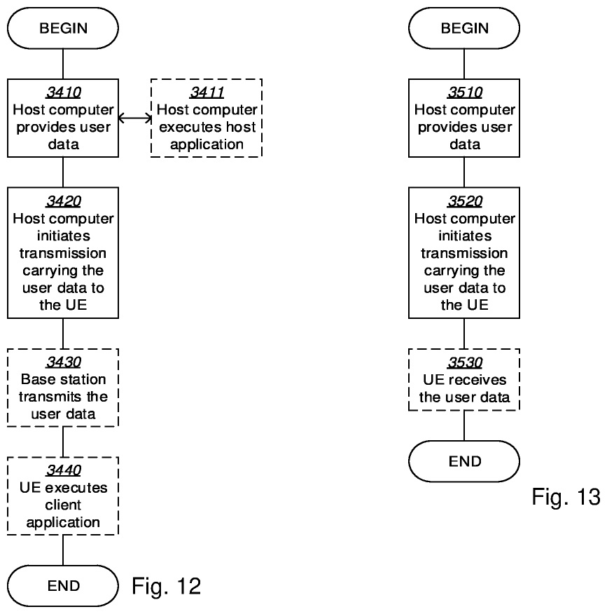

FIG. 12 is a flowchart illustrating a method implemented in a communication system, in accordance with one embodiment. The communication system includes a host computer, a base station and a UE which may be those described with reference to FIGS. 10 and 11. For simplicity of the present disclosure, only drawing references to FIG. 12 will be included in this section. In a first step 3410 of the method, the host computer provides user data. In an optional substep 3411 of the first step 3410, the host computer provides the user data by executing a host application. In a second step 3420, the host computer initiates a transmission carrying the user data to the UE. In an optional third step 3430, the base station transmits to the UE the user data which was carried in the transmission that the host computer initiated, in accordance with the teachings of the embodiments described throughout this disclosure. In an optional fourth step 3440, the UE executes a client application associated with the host application executed by the host computer.

FIG. 13 is a flowchart illustrating a method implemented in a communication system, in accordance with one embodiment. The communication system includes a host computer, a base station and a UE which may be those described with reference to FIGS. 10 and 11. For simplicity of the present disclosure, only drawing references to FIG. 13 will be included in this section. In a first step 3510 of the method, the host computer provides user data. In an optional substep (not shown) the host computer provides the user data by executing a host application. In a second step 3520, the host computer initiates a transmission carrying the user data to the UE. The transmission may pass via the base station, in accordance with the teachings of the embodiments described throughout this disclosure. In an optional third step 3530, the UE receives the user data carried in the transmission.

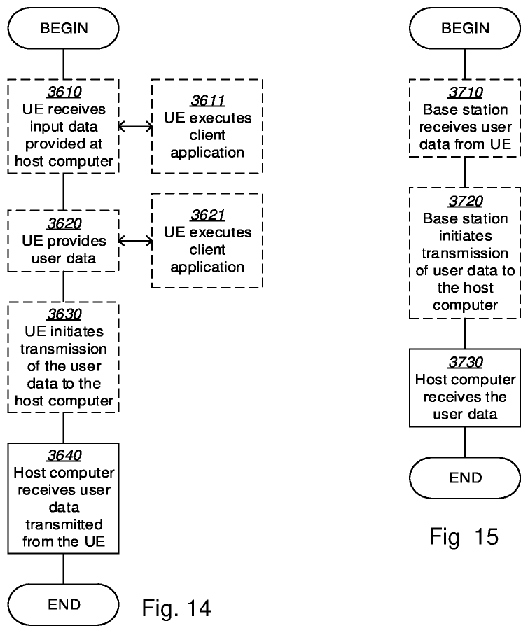

FIG. 14 is a flowchart illustrating a method implemented in a communication system, in accordance with one embodiment. The communication system includes a host computer, a base station and a UE which may be those described with reference to FIGS. 10 and 11. For simplicity of the present disclosure, only drawing references to FIG. 14 will be included in this section. In an optional first step 3610 of the method, the UE receives input data provided by the host computer. Additionally or alternatively, in an optional second step 3620, the UE provides user data. In an optional substep 3621 of the second step 3620, the UE provides the user data by executing a client application. In a further optional substep 3611 of the first step 3610, the UE executes a client application which provides the user data in reaction to the received input data provided by the host computer. In providing the user data, the executed client application may further consider user input received from the user. Regardless of the specific manner in which the user data was provided, the UE initiates, in an optional third substep 3630, transmission of the user data to the host computer. In a fourth step 3640 of the method, the host computer receives the user data transmitted from the UE, in accordance with the teachings of the embodiments described throughout this disclosure.

FIG. 15 is a flowchart illustrating a method implemented in a communication system, in accordance with one embodiment. The communication system includes a host computer, a base station and a UE which may be those described with reference to FIGS. 10 and 11. For simplicity of the present disclosure, only drawing references to FIG. 15 will be included in this section. In an optional first step 3710 of the method, in accordance with the teachings of the embodiments described throughout this disclosure, the base station receives user data from the UE. In an optional second step 3720, the base station initiates transmission of the received user data to the host computer. In a third step 3730, the host computer receives the user data carried in the transmission initiated by the base station.

It will be appreciated that the foregoing description and the accompanying drawings represent non-limiting examples of the methods and apparatus taught herein. As such, the apparatus and techniques taught herein are not limited by the foregoing description and accompanying drawings. Instead, the embodiments herein are limited only by the following claims and their legal equivalents.

### Abbreviations

3GPP 3^{rd} Generation Partnership Project
CA Carrier Aggregation
CN Core Network
CP Control Plane
CU Central Unit
CU-CP Central Unit—Control Plane
CU-UP Central Unit—User Plane
DL Downlink
DU Distributed Unit
eNB eNodeB
eNodeB Evolved NodeB
EUTRA Evolved Universal Terrestrial Radio Access
F1 The interface between a CU and a DU.
F1-U The user plane part of the F1 interface, e.g. between a CU-UP and a DU.
gNB Radio base station in NR.
LTE Long Term Evolution
MAC Medium Access Control
MCG Master Cell Group
MDT Minimization of Drive Tests
MN Master Node
NR New Radio
PDCP Packet Data Convergence Protocol
RAN Radio Access Network
RAT Radio Access Technology
RLC Radio Link Control
RLF Radio Link Failure
RNC Radio Network Controller
RRC Radio Resource Control
SN Secondary Node
TCE Trace Collection Entity
TS Technical Specification
UE User Equipment
UL Uplink
UP User Plane

### REFERENCES

[1] TS 38.401, NG-RAN; Architecture description, version 16.7.0, 3GPP
[2] TS 38.314, NR; Layer 2 measurements, version 16.4.0, 3GPP
[3] TS 37.320, Universal Terrestrial Radio Access (UTRA) and Evolved Universal Terrestrial Radio Access (E-UTRA); Radio measurement collection for Minimization of Drive Tests (MDT); Overall description; Stage 2, V 16.6.0
[4] TS 28.552; Management and orchestration; 5G performance measurements, V 17.4.0
[5] TS 38.331; NR; Radio Resource Control (RRC); Protocol specification, V 16.6.0

1.-22. (canceled)

23. A method performed by a network node, for calculating an uplink (UL) radio access network average delay in a wireless communication network comprising a first radio network node and a second radio network node providing dual connectivity to a user equipment (UE), the method comprising:
applying a weighting to a number of packets respectively sent via the first radio network node and the second radio network node when no packet duplication is applied or to a time period during which packets were sent via the first radio network node or the second radio network node when no packet duplication is applied, wherein the weighting further includes a number of packets sent via the first radio network node and the second radio network node when packet duplication is applied or a time period during which packets were sent via the first radio network node and the second radio network node when packet duplication is applied, and wherein the weighting also includes a respective delay calculation for one or more packets, or periods, with duplication, and one or more packets, or periods, without duplication; and
calculating an UL radio access network average delay of a packet transmission taking into account the applied weighting, and further also taking into account an uplink delay component reported by the UE, wherein the uplink delay component is not separated into a first radio network node part and a second radio network node part.

24. The method according to claim 23, further comprising
obtaining one or more indications of the respective delay calculation and number of packets transmitted with duplication and/or non-duplication over a respective period.

25. The method according to claim 23, wherein the weighting comprises deriving a first weight for a first delay calculated at the first radio network node and a second weight for a second delay calculated at the second radio network node, on the basis of at least one of the following:
a first number of packets for a given bearer sent via the first radio network node and a second number of packets sent via the second radio network node when the duplication was not enabled and the first and second delays experienced by packets of the first radio network node and the second radio network node; and/or
a third number of packets for the given bearer sent via both the first radio network node and the second radio network node when the duplication was enabled and the first and second delays experienced by packets of the first radio network node and the second radio network node.

26. The method according to claim 23, wherein the uplink delay component comprises a single value for Uplink packet data convergence protocol (PDCP) average queueing delay or indicate an UL PDCP packet average delay over a bearer between the UE and the first and second radio network node.

27. The method according to claim 23, wherein calculating the UL radio access network average delay is further taking into account that a bearer switches between being a split bearer in a dual connectivity scenario and being a regular bearer in a single connectivity scenario.

28. The method according to claim 23, wherein calculating the UL radio access network average delay is accounted separately for different secondary nodes (SN) or secondary cell group (SCG) cells.

29. The method according to claim 23, wherein calculating the UL radio access network average delay is further taking into account sub-periods or packets sent in conjunction with different bearer properties.

30. The method according to claim 23, further comprising initiating usage of the calculated UL radio access network average delay.

31. The method according to claim 30, wherein the calculated UL radio access network average delay is used for operation administration and maintenance (OAM), performance observability or for quality of service (QoS), verification of minimization drive test (MDT), or for QoS monitoring.

32. The method according to claim 23, wherein the calculated UL radio access network average delay further takes into account an average delay in a central unit-user plane (CU-UP) during a measurement period.

33. A network node for calculating an uplink (UL) radio access network average delay in a wireless communication network comprising a first radio network node and a second radio network node providing dual connectivity to a user equipment (UE), wherein the network node comprises processing circuitry configured to:
apply a weighting to a number of packets respectively sent via the first radio network node and the second radio network node when no packet duplication is applied or to a time period during which packets were sent via the first radio network node or the second radio network node when no packet duplication is applied, wherein the weighting further includes a number of packets sent via the first radio network node and the second radio network node when packet duplication is applied or a time period during which packets were sent via the first radio network node and the second radio network node when packet duplication is applied, and wherein the weighting also includes a respective delay calculation for one or more packets, or periods, with duplication, and one or more packets, or periods, without duplication, and
calculate an UL radio access network average delay of a packet transmission taking into account the weighting, and further also taking into account an uplink delay component reported by the UE, wherein the uplink delay component is not separated into a first radio network node part and a second radio network node part.

34. The network node according to claim 33, wherein the processing circuitry is configured to obtain one or more indications of the respective delay calculation and number of packets transmitted with duplication and/or non-duplication over a respective period.

35. The network node according to claim 33, wherein the weighting comprises deriving a first weight for a first delay calculated at the first radio network node and a second weight for a second delay calculated at the second radio network node, on the basis of at least one of the following:
a first number of packets for a given bearer sent via the first radio network node and a second number of packets sent via the second radio network node when the duplication was not enabled and the first and second delays experienced by packets of the first radio network node and the second radio network node; and/or
a third number of packets for the given bearer sent via both the first radio network node and the second radio network node when the duplication was enabled and the first and second delays experienced by packets of the first radio network node and the second radio network node.

36. The network node according to claim 33, wherein the uplink delay component comprises a single value for Uplink packet data convergence protocol (PDCP) average queueing delay or indicate an UL PDCP packet average delay over a bearer between the UE and the first and second radio network node.

37. The network node according to claim 33, wherein the processing circuitry is configured to calculate the UL radio access network average delay by further taking into account that a bearer switches between being a split bearer in a dual connectivity scenario and being a regular bearer in a single connectivity scenario.

38. The network node according to claim 33, wherein the processing circuitry is configured to calculate the UL radio access network average delay separately for different secondary nodes (SN) or secondary cell groups (SCG) cells.

39. The network node according to claim 33, wherein the processing circuitry is configured to calculate the UL radio access network average delay by further taking into account:
sub-periods or packets sent in conjunction with different bearer properties; and/or
an average delay in a central unit-user plane (CU-UP) during a measurement period.

40. The network node according to claim 33, wherein the processing circuitry is further configured to initiate usage of the calculated UL radio access network average delay.

41. The network node according to claim 40, wherein the calculated UL radio access network average delay is used for operation administration and maintenance (OAM), performance observability or for quality of service (QoS), verification of minimization drive test (MDT), or for QoS monitoring.

42. A computer-readable storage medium, having stored thereon a computer program product comprising instructions which, when executed on at least one processor of a network node, cause the at least one processor to carry out the method according to claim 23.
